(19) United States
(12) Patent Application Publication
(10) Pub. No.: US 2012/0030203 A1
(43) Pub. Date: Feb. 2, 2012

(54) METHOD FOR ESTABLISHING MULTIPLE LOOK-UP TABLES AND DATA ACQUISITION METHOD USING MULTIPLE LOOK-UP TABLES

(75) Inventors: Hsiao-Lan Chiang, Miaoli County (TW); Pang-An Ting, Taichung County (TW); Kuo-Tai Chiu, Taoyuan County (TW)

(73) Assignee: Industrial Technology Research Institute, Hsinchu (TW)

(21) Appl. No.: 12/902,154

(22) Filed: Oct. 12, 2010

(30) Foreign Application Priority Data
Jul. 28, 2010 (TW) 99124913

(51) Int. Cl. G06F 17/30

(52) U.S. Cl. 707/737; 707/E17.089

(57) ABSTRACT

A method for establishing multiple look-up tables and a data acquisition method using multiple look-up tables are provided. In the present method, a plurality of input data is classified into a plurality of groups, and a plurality of input data and a plurality of output data corresponding to the input data are respectively provided to the groups to establish a plurality of corresponding look-up tables. At least one bit is selectively removed from the input data in each of the look-up tables corresponding to at least one of the groups, and the result input data and the corresponding output data are recorded in the look-up table corresponding to the group.

### CROSS-REFERENCE TO RELATED APPLICATION

This application claims the priority benefit of Taiwan application serial no. 99124913, filed on Jul. 28, 2010. The entirety of the above-mentioned patent application is hereby incorporated by reference herein and made a part of this specification.

### TECHNICAL FIELD

The disclosure relates to a data acquisition method, and more particularly, to a data acquisition method using multiple look-up tables.

### BACKGROUND

Data conversions are often performed in digital circuits. Such conversion operations are very complicated and consume a lot of time and system resources. In order to reduce system load, such conversion operations are usually carried out through table lookup instead of being directly calculated by a processor. In the table lookup technique, possible input data is pre-converted, and the conversion result is stored into a device memory as a look-up table. When subsequently the same data is to be actually converted, the conversion result is obtained by acquiring the corresponding data from the look-up table. Accordingly, the processor does not need to perform the conversion operation repeatedly, so that the consumptions of time and system resources and the system cost can all be reduced.

However, the size of the look-up table increases along with the variation range of the input data in order to provide a complete operation result. Besides, the size of the look-up table is further increased if a highly accurate operation result is desired. Either situation causes the look-up table to take up more system resources. For example, if the input data and the output data both have 16 bits, the corresponding look-up table may take up a memory space of up to hundreds of kilobytes in order to provide a high-quality output signal corresponding to an input signal. Thereby, the conventional table lookup technique is not so satisfactory to a system with limited memory space or heavy load on memory access.

### SUMMARY

A method for establishing multiple look-up tables and a data acquisition method using multiple look-up tables are introduced herein.

According to an exemplary embodiment, a method for establishing multiple look-up tables is provided, wherein data is recorded into a plurality of look-up tables, and at least one bit is selectively removed from the data in each of the look-up tables to reduce the size of the look-up table.

According to an exemplary embodiment, a method for establishing multiple look-up tables is provided. The present method allows an electronic device to search for an output data corresponding to an input data. In the present method, a plurality of input data is classified into a plurality of groups, and a plurality of input data and a plurality of output data corresponding to the input data are respectively provided to the groups to establish a plurality of corresponding look-up tables. Then, at least one bit is selectively removed from the input data in each of the look-up tables corresponding to at least one of the groups, and the result input data and the corresponding output data are recorded in the look-up table corresponding to the group.

The present disclosure provides a data acquisition method using multiple look-up tables. The data acquisition method allows an electronic device to acquire an output data corresponding to an input data. In the data acquisition method, a plurality of look-up tables is provided, wherein at least one bit is selectively removed from a plurality of input data classified into one of a plurality of groups, and the result input data and the corresponding output data are recorded in each of the look-up tables. Then, an input data is received, and the output data corresponding to the input data is acquired from the look-up table.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1(a) and FIG. 1(b) illustrate an example of cosine transform look-up table according to an embodiment.

FIG. 2 is a flowchart of a method for establishing multiple look-up tables according to an embodiment.

FIG. 3 is a flowchart of a method for establishing multiple look-up tables according to an embodiment.

FIG. 4 illustrates an example of multiple look-up tables corresponding to a division operation according to an embodiment.

FIG. 5 illustrates an example of multiple look-up tables corresponding to a divider according to an embodiment.

FIG. 6 is a flowchart of a method for establishing multiple look-up tables according to an embodiment.

FIG. 7 illustrates an example of an N-bit search window according to an embodiment.

FIG. 8 illustrates an example of look-up tables corresponding to a linear-to-logarithmic conversion operation according to an embodiment.

FIG. 9 is a flowchart of a data acquisition method using multiple look-up tables according to an embodiment.

### DETAILED DESCRIPTION OF DISCLOSED EMBODIMENTS

An exemplary embodiment provides a method for establishing multiple look-up tables and a data acquisition method using multiple look-up tables.

In the present exemplary embodiment, a plurality of input data is classified into a plurality of groups according to the numerical distribution of the input data, and the classified input data is recorded into different look-up tables. At least one bit is selectively removed from the input data recorded in each of the look-up tables without affecting the data accuracy, and only the result input data and the corresponding output data are recorded.

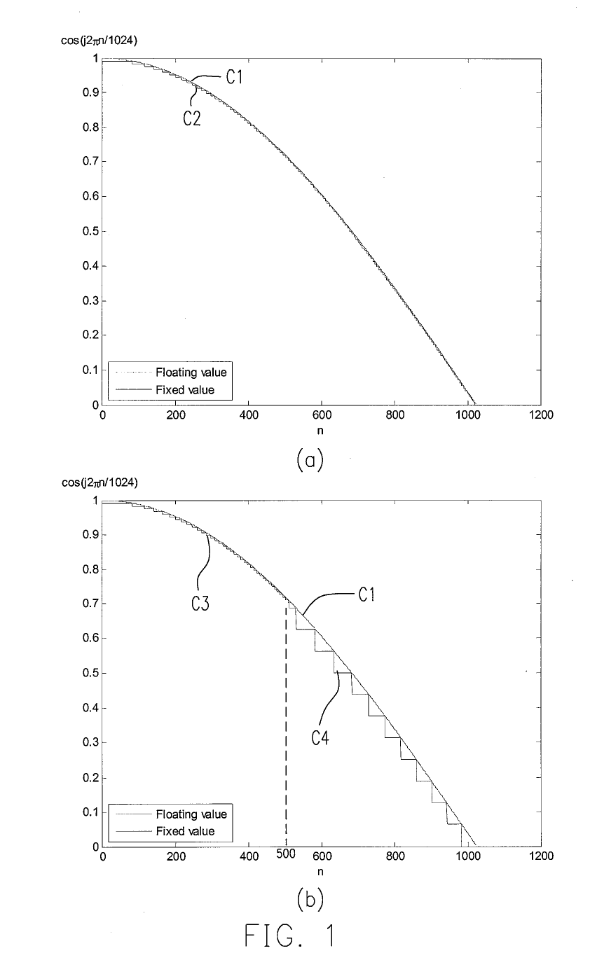

FIG. 1(a) and FIG. 1(b) illustrate an example of cosine transform look-up table according to an embodiment, wherein n=1−N (N=1024) is an integer input, cos(j2πn/N) is the output. In FIG. 1(a) and FIG. 1(b), C1 is the floating-point value of cos(j2πn/N), while C2-C4 are all 16-bit values of cos(j2πn/N). As shown in FIG. 1(a), a step curve C2 consistent with the floating-point cosine curve C1 is obtained if all the conversion results of the input data are recorded in a look-up table. However, if the input data n received by the system is mostly smaller than 500, the input data n exceeding this range is simplified to reduce the size of the look-up table for recording data. As shown in FIG. 1(b), all the conversion results corresponding to the input data n between 1-500 in the FIG. 1(a) are recorded in the look-up table. Thus, the curve C3 corresponding to the input/output data within this range is still consistent with the cosine curve C1. However, the curve C4 corresponding to the input/output data outside this range (i.e., n=501-1024) is not consistent with the cosine curve C1.

The difference between foregoing two look-up table designs is listed in following table 1. The design with a single look-up table and a curve consistent with the cosine curve has an ideal (−46 dB) mean square error (MSE) but has a table size of up to 130*16 bits. Contrarily, the design with multiple look-up tables and a curve inconsistent with the cosine curve has a MSE (−43 dB) close to that in the design with a single look-up table but has a reduced table size of 52*16 bits. Thus, the size of the look-up table is effectively reduced by adopting multiple look-up tables, and accordingly less memory space is required.

TABLE 1

| | MSE (dB) | Size (16 bits) |
|---|---|---|
| Consistent | −46 | 130 |
| Inconsistent | −43 | 40 (n < 500) |
| | | 12 (n ≧ 500) |

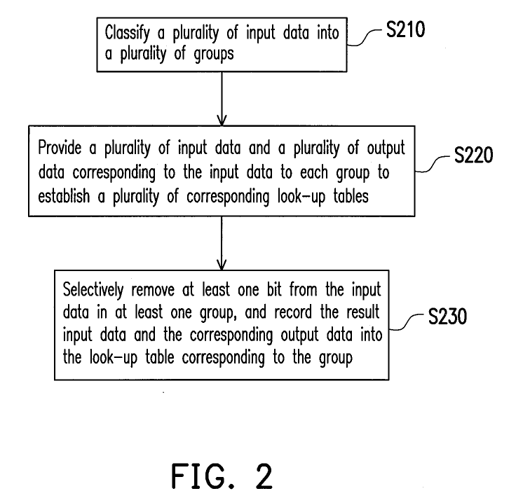

Based on the concept described above, a method for establishing multiple look-up tables is provided in the present exemplary embodiment. FIG. 2 is a flowchart of a method for establishing multiple look-up tables according to an embodiment. Referring to FIG. 2, in the method provided by the present embodiment, look-up tables are established such that an electronic device can search for an output data corresponding to an input data. Below, the method will be described in detail.

First, a plurality of input data is classified into a plurality of groups by the electronic device (step S210). In an embodiment, the electronic device may classify the input data according to the numerical distribution of the input data, while in another embodiment, the electronic device may also determine the number and sizes of the groups according to the attributes of the output data, the capacity of the memory, or the speed of the processor. How the electronic device classifies the input data is not limited in the present embodiment.

A plurality of input data and a plurality of output data corresponding to the input data are respectively provided to each of the groups by the electronic device (step S220). The input data may be automatically generated by the electronic device, and the corresponding output data may also be generated by the electronic device by pre-converting the input data. For example, the output data may be obtained by performing a sin/cos operation, a division operation, or a logarithmic operation on the input data, and the input data and the output data may have 16 bits or other same or different numbers of bits. How the output data is obtained and the sizes of the input data and the output data are not limited in the present embodiment.

And, at least one bit is selectively removed from the input data in at least one look-up table corresponding to at least one of foregoing groups by the electronic device, and the result input data and the corresponding output data are recorded into the look-up table corresponding to the group by the electronic device (step S230). To be specific, an operation result may have a portion converging to a specific value and a portion with inconspicuous variations, or the input data may be concentrated within a specific range. In the present exemplary embodiment, an appropriate number of bits is removed from the input data recorded in the look-up table regarding aforementioned specific portions (i.e., indirectly reduce the total number of input/output data recorded in the look-up table), so as to reduce the size of the look-up table.

Accordingly, every time when the electronic device receives an input data, it acquires the corresponding output data from the look-up table established above, and since the size of the look-up table and the number of bits in the input data have been both reduced, less data is searched by the electronic device in the look-up table, so that the speed for acquiring data is increased.

It should be noted that in order to prevent the result data from varying too much from the original value, in the present exemplary embodiment, a plurality of bit removal simulations is performed on each look-up table, and the error of each bit removal simulation is calculated. The bit removal simulation having the most removable bits within a tolerable range of data accuracy is selected. Data bits are removed from the data recorded in each look-up table and the number of data recorded in the look-up table is reduced according to the selected bit removal simulation, so that the size of the look-up table can be reduced. Below, this technique will be described in detail with reference to another embodiment.

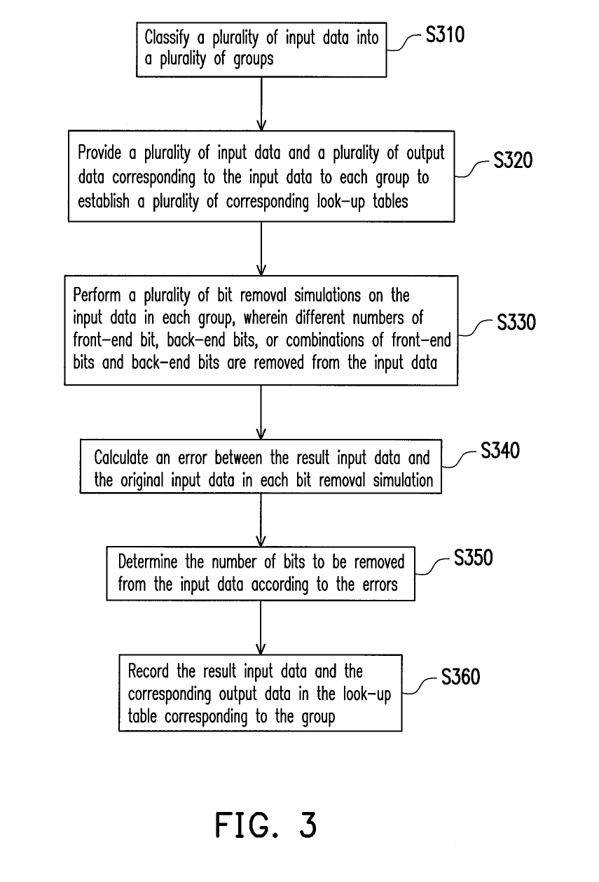

FIG. 3 is a flowchart of a method for establishing multiple look-up tables according to an embodiment. Referring to FIG. 3, in the method provided by the present embodiment, look-up tables are established such that an electronic device can search for an output data corresponding to an input data. Below, the present method will be described in detail.

First, a plurality of input data is classified into a plurality of groups by the electronic device (step S310). Then, a plurality of input data and a plurality of output data corresponding to the input data are respectively provided to the groups by the electronic device (step S320). The steps S310 and 5320 are the same as or similar to the steps S210 and S220 in the embodiment described above therefore will not be described herein.

However, unlike the embodiment described above, in the present embodiment, after the electronic device classifies the input data, it further performs a plurality of bit removal simulations on the input data in each group. In these bit removal simulations, different numbers of front-end bits, back-end bits, or combinations of the front-end bits and the back-end bits are removed from the input data (step S330). For example, assuming that the original input data has 16 bits and the 16 bits include 5 integral bits and 11 decimal bits, in the bit removal simulations provided by the present disclosure, 1-2 bits in the front (i.e., the integral part) of the input data, 1-2 bits at the back (i.e., the decimal part) of the input data, or 1-2 bits respectively in the front or at the back of the input data can be deleted to reduce the number of bits in the input data.

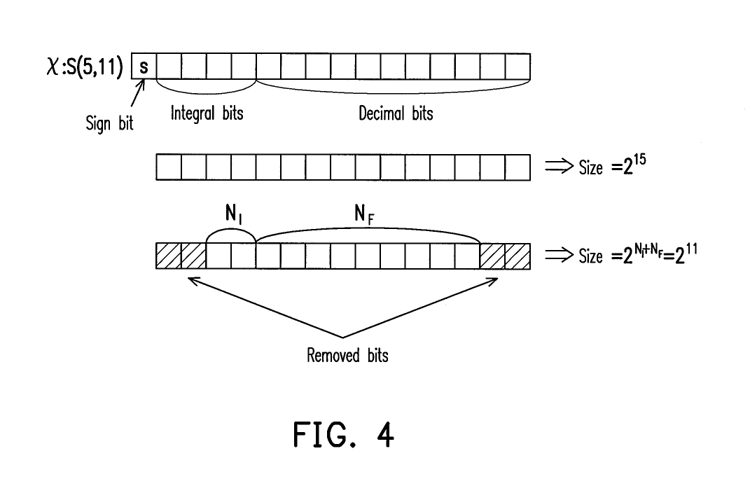

FIG. 4 illustrates an example of multiple look-up tables corresponding to a division operation according to an embodiment. Referring to FIG. 4, assuming each input data or output data in the look-up table has 16 bits and the 16 bits include 1 sign bit, 4 integral bits, and 11 decimal bits, as shown in FIG. 4, the table size is up to 2¹⁵×16 bits if the complete 16-bit data is recorded in the look-up table. If two integral bits and two decimal bits are removed, the table size is then reduced to 2¹¹×16 bits.

The total MSE and table size corresponding to each bit removal simulation are listed in following table 2, wherein N_{I} and N_{F} respectively represent the number of integral bits and the number of decimal bits in the result data, and the total MSE is calculated through following formula:

MSE=Σ|x_{quan}⁻¹−x⁻¹|² (1)

In foregoing formula (1), x⁻¹ represents the floating-point reciprocal value of the input data x, and x_{quan}⁻¹ represents the quantized value of x⁻¹. As shown in table 2, the overall error of the look-up table increases along with the number of removed bits, but the size of the look-up table decreases along with the number of removed bits.

TABLE 2

| (N_{I}, N_{F}) | MSE (dB) | Size (16 bits) |
|---|---|---|
| (3, 11) | −56.5645 | 16384 |
| (2, 11) | −36.6489 | 8192 |
| (1, 11) | −18.745 | 4096 |
| (4, 10) | −36.8381 | 16384 |
| (3, 10) | −34.331 | 8192 |
| (2, 10) | −33.7464 | 4096 |
| (1, 10) | −18.6785 | 2048 |
| (4, 9) | −29.0342 | 8192 |
| (3, 9) | −29.0309 | 4096 |
| (2, 9) | −28.3438 | 2048 |
| (1, 9) | −18.3568 | 1024 |

After the bit removal simulation to be performed is determined, the error between the result input data and the original input data in each bit removal simulation is calculated by the electronic device (step S340). Herein the error may be the total MSE of a plurality of corresponding input data (before and after the bits are removed).

The bit removal simulation eventually adopted and the number of bits to be removed from the input data are determined according to the errors of the bit removal simulations (step S350). Herein the bit removal simulation eventually adopted is determined according to the overall error of all the look-up tables or the individual errors of the look-up tables.

To be specific, to determine the bit removal simulation adopted in each look-up table according to the overall error of all the look-up tables, the total error of all the look-up tables corresponding to one of a plurality of combinations of the bit removal simulations performed in the look-up tables is calculated. The total error is then compared with the original error of the input data, and the combination having the total error closest to the original error is selected for determining the bit removal simulation adopted in each look-up table and the number of bits to be removed from the input data.

On the other hand, to determine the bit removal simulation adopted in each look-up table according to the individual errors of all the look-up tables, the bit removal simulation having the smallest error is selected from all the bit removal simulations performed in each look-up table, so as to determine the number of bits to be removed from the input data in the look-up table.

Finally, data bits are removed from the input data by the electronic device according to the selected bit removal simulation, and the result input data and the corresponding output data are recorded into the look-up table corresponding to the group the electronic device (step S360). By now, multiple look-up tables are established.

Through the technique described above, in the present embodiment, an appropriate number of bits are removed from the input data in each look-up table, so that the total number of input/output data recoded in each look-up table is reduced indirectly. Accordingly, the size of each look-up table can be reduced within the tolerable range of data accuracy. Below, how to balance between the execution performance and the size of a look-up table in an actual application through the method described above will be explained according to an embodiment.

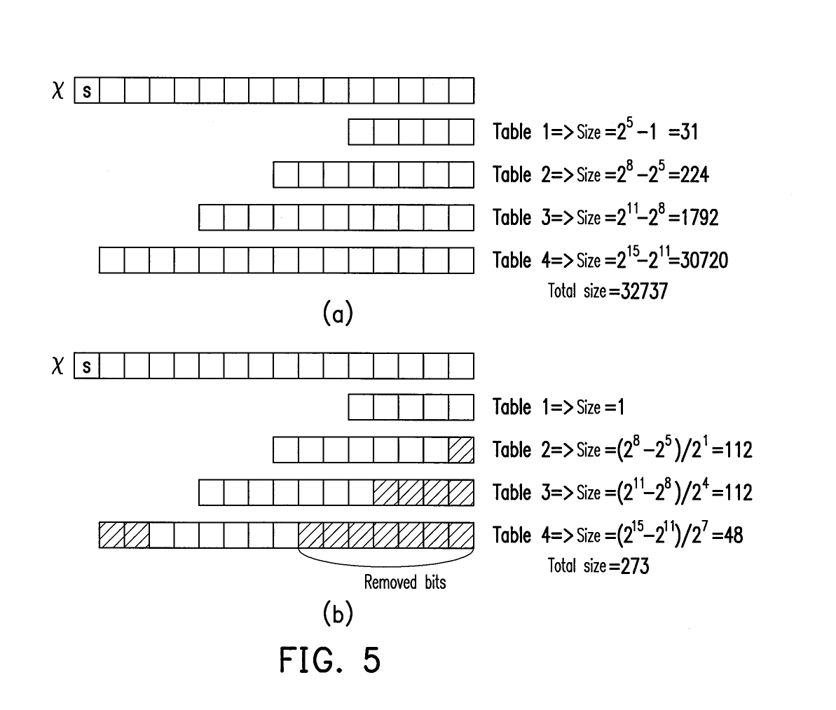

FIG. 5 illustrates an example of multiple look-up tables corresponding to a divider according to an embodiment. Referring to FIG. 5, in the present embodiment, how to establish multiple look-up tables corresponding to a plurality of input data and the corresponding output data obtained by performing division operations on the input data will be described by taking a divider as an example. In the present embodiment, a plurality of 16-bit input data x is classified into 4 groups based on following rules:

x′=x×2¹¹ (2)

if x′<=2⁵−1

//Table 1

address=x′

elseif x′<=2⁸−1

//Table 2

address=(x′−2⁵)>>1

elseif x′<=2¹¹−1

//Table 3

address=(x′−2⁸)>>4

else

//Table 4

address=(x′−2¹¹)>>7

In order to directly serve the input data as the addresses of the look-up tables, in foregoing expression (2), the data x′ is obtained by multiplying the input data x (containing 11 decimal bits) by 2¹¹, so as to convert the input data x into an integer. Foregoing tables 1-4 will be explained below.

Regarding table 1, in the present embodiment, it is assumed the output data of the divider is composed of 1 sign bit, 6 integral bits, and 9 decimal bits. Namely, the maximum output value of the divider should be smaller than 2⁶. By taking the range of the input data into consideration, if the input data is smaller than 2⁻⁶−1, the corresponding output data is quantized into the maximum value of (N_{I},N_{F})=(7,9).

Thus, the input data smaller than 2⁻⁶−1 are classified into the same look-up table, and as long as an input data falls within this range, the corresponding output data can be acquired from this look-up table. Herein because the input data x is first multiplied by 2¹¹, the input condition in foregoing expression (2) is 2⁻⁶×2¹¹−1=2⁵−1.

Regarding tables 2 and 3, the input data between 2⁻⁶ and 1 is classified into two look-up tables, wherein the input data between 2⁻⁶ and 2⁻³−1 is classified in the table 2, and the input data between 2⁻³ and 2⁰−1 is classified in the table 3. Because the results of the bit removal simulations indicate that the accuracy of the output data corresponding to the input data between 2⁻⁶ and 2⁻³−1 has to be maintained, only one decimal bit is removed from the input data. Similarly, the results of the bit removal simulations indicate that more data bits can be removed from the input data between 2⁻³ and 2⁰−1.

Regarding table 4, the input data in this look-up table contains only integral bits. In this case, the accuracy of the corresponding output data is not affected by the number of removed decimal bits. Thus, any number of decimal bits can be removed.

The results of the bit removal simulations performed in each of foregoing look-up tables are listed in following table 3, the numbers in the brackets respectively represent the integral bits and the decimal bits of the original input data and the decimal bits to be removed.

TABLE 3

| Table 1 | Table 2 | Table 3 | Table 4 | MSE (dB) | Size (16 bits) |
|---|---|---|---|---|---|
| (0, 5, 0) | (0, 8, 0) | (0, 11, 0) | (4, 11, 0) | −64.9281 | 32737 |
| (0, 5, 0) | (0, 8, 0) | (0, 11, 0) | (4, 11, 7) | −38.609 | 2257 |
| (0, 5, 0) | (0, 8, 0) | (0, 11, 4) | (4, 11, 7) | −31.0597 | 577 |
| (0, 5, 0) | (0, 8, 0) | (0, 11, 4) | (2, 11, 7) | −30.2356 | 385 |
| (0, 5, 0) | (0, 8, 1) | (0, 11, 4) | (2, 11, 7) | −28.9486 | 273 |
| (0, 5, 0) | (0, 8, 2) | (0, 11, 4) | (2, 11, 7) | −25.4082 | 217 |

As shown in foregoing table 3, when 1 bit is removed from the input data in table 2, 4 bits are removed from the input data in table 3, and 7 bits are removed from the input data in table 4, the error (−28.9486) does not change a lot compared to the results of other bit removal simulations. If this bit removal simulation is selected, the total size of the look-up tables can be reduced from 32737×16 bits (as shown in FIG. 5(a)) to 273×16 bits (as shown in FIG. 5(b)).

It should be noted that besides selecting the bit removal simulation in each look-up table according to aforementioned errors, in the present exemplary embodiment, the bit removal simulation is also selected by taking the system memory space into consideration, so that a bit removal simulation which allows the size of the look-up table to be supported by the system can be selected. Below, this will be described in detail with reference to another embodiment.

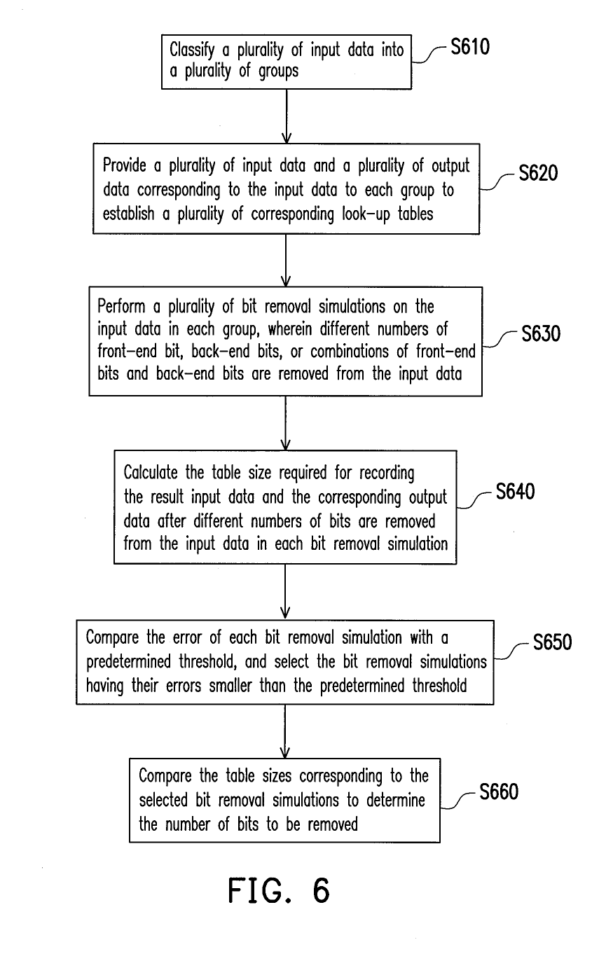

FIG. 6 is a flowchart of a method for establishing multiple look-up tables according to an embodiment. Referring to FIG. 6, in the present embodiment, look-up tables are established such that an electronic device can search for an output data corresponding to an input data. Below, the method will be described in detail.

First, a plurality of input data is classified into a plurality of groups by the electronic device (step S610). Then, a plurality of input data and a plurality of output data corresponding to the input data are respectively provided to each group by the electronic device (step S620). And a plurality of bit removal simulations are performed on the input data in each group by the electronic device, wherein different numbers of front-end bits, back-end bits, or combinations of the front-end bits and the back-end bits are removed from the input data (step S630). Foregoing steps S610-S630 are the same as or similar to the steps S310-S330 in the embodiment described above therefore will not be described herein.

However, unlike the embodiment described above, in the present embodiment, after the bit removal simulation adopted in each look-up table is selected by the electronic device, the table size required for recording the result input data and the corresponding output data after different numbers of bits are removed from the input data in each bit removal simulation is further calculated by the electronic device (step S640).

While determining the eventually adopted bit removal simulation, the error of each bit removal simulation is compared with a predetermined threshold, and the bit removal simulations having their errors smaller than the threshold (i.e., within an acceptable error range) are selected (step S650). After that, the table sizes required corresponding to the bit removal simulations are compared by the electronic device, so as to determine the number of bits to be eventually removed from the input data (step S660).

For example, the results of three bit removal simulations respectively corresponding to the tables 2-4 in foregoing table 3 are listed in following table 4. If the predetermined threshold is −15 dB, the bit removal simulations (0,8,0) and (0,8,1) are selected corresponding to table 2, and the table sizes are then compared to select the bit removal simulation (0,8,1) having the smaller table size (112). Similarly, the bit removal simulations (0,11,4) and (2,11,7) are respectively selected corresponding to table 3 and table 4.

TABLE 4

| | MSE(dB) | Size (16 bits) |
|---|---|---|
| Table 2 | | |
| (0, 8, 0) | −65.2988 | 224 |
| (0, 8, 1) | −15.1960 | 112 |
| (0, 8, 2) | −7.4788 | 56 |
| Table 3 | | |
| (0, 11, 0) | −64.8281 | 1792 |
| (0, 11, 2) | −39.1220 | 448 |
| (0, 11, 4) | −2535257 | 112 |
| Table 4 | | |
| (4, 11, 0) | −64.9538 | 30720 |
| (2, 11, 0) | −37.3120 | 6144 |
| (2, 11, 7) | −34.0092 | 48 |

It should be noted that through the method provided by foregoing embodiment, the sizes of the look-up tables are effectively reduced, and the number of input/output data to be stored is also reduced. Since less input data is stored, the method for recording the addresses of the input data is also simplified. To be specific, after the electronic device removes the bits from the input data in each group and establishes the corresponding look-up tables, it calculates the size of each look-up table for recording the result input data and the corresponding output data. The electronic device can obtain the addresses corresponding to the input data in the look-up tables according to the threshold of the input data and the removed bits. Herein the electronic device may assign addresses to the input data in each look-up table individually or connect the addresses of the input data in all the look-up tables to allow the input data to have continuous addresses.

In another embodiment, the method for establishing multiple look-up tables is applied to a logarithmic operation. Herein the logarithmic operation comes with a special rule. Namely, assuming the logarithmic value of a value A₁ is B₁ and B₁=10 log₁₀A₁, if the binary sequence of a value A₂ is obtained by shifting the binary sequence of the value A₁ rightwards for one bit (i.e., the value A₂ is half of the value A₁), the logarithmic value B₂ of the value A₂ can be directly obtained from the logarithmic value B₁ of the value A₁, so that it is not needed to record the logarithmic value B₂ in the look-up table. How the logarithmic value B₂ is deduced from the logarithmic value B₁ is expressed as:

$$\begin{matrix}{B}_{2} = 10 {log}_{10} {A}_{2} \\ = 10 {log}_{10} \frac{{A}_{1}}{2} \\ = 10 {log}_{10} {A}_{1} - 10 {log}_{10} 2 \\ = 10 {log}_{10} {A}_{1} - 3.01\end{matrix} \qquad ( 3 )$$

Based on aforementioned rule, in the present exemplary embodiment, a N-bit search window is slid on the binary sequence of an original data to scan from the most significant bit (MSB) to the least significant bit (LSB) of the binary sequence, so as to find the first bit having the value 1 in the binary sequence, wherein N is a positive integer.

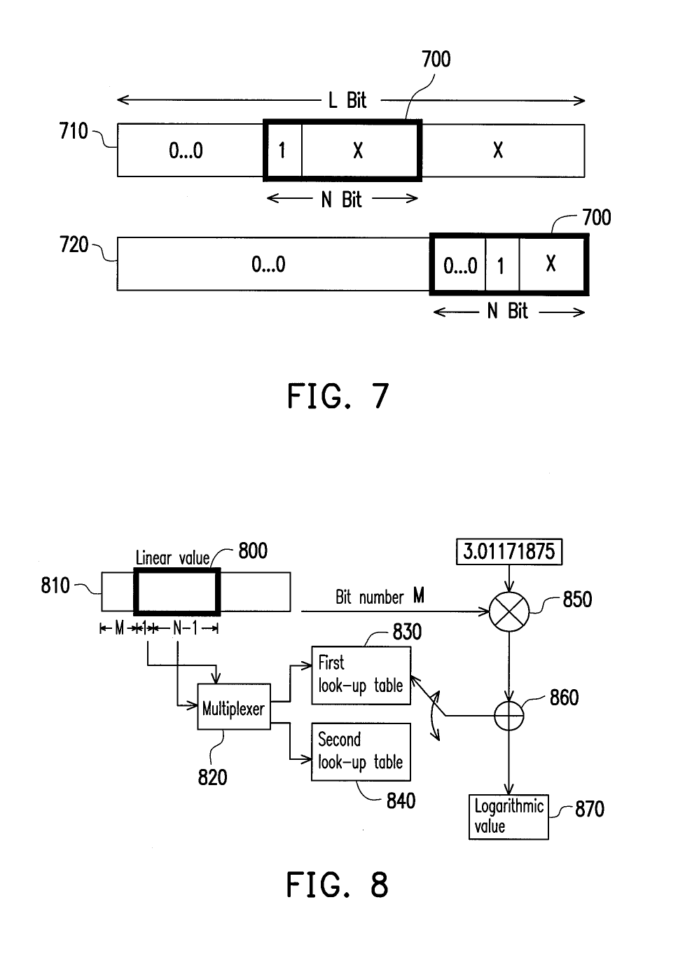

FIG. 7 illustrates an example of an N-bit search window according to an embodiment. Referring to FIG. 7, it is assumed that the original data 710 has L bits, and the search window 700 has N bits, wherein L and N are both positive integers and N is smaller than L. Herein the search window 700 searches for the first bit having the value 1 starting from the MSB of the binary sequence of the original data 710. When the search window 700 finds the first bit having the value 1, the value of the N bits within the search window 700 is served as the input data corresponding to the original data 710 and is recorded in a first look-up table. It should be noted that if the search window 700 does not find any bit having the value 1 when it reaches the LSB of the binary sequence of the original data 720, the value of the last N bits of the original data 720 is recorded in a second look-up table so that the established look-up tables can be corresponded to the value of the original data 720.

FIG. 8 illustrates an example of look-up tables corresponding to a linear-to-logarithmic conversion operation according to an embodiment. Referring to FIG. 8, in the present embodiment, the logarithmic value of an input data 810 is searched by using two look-up tables (i.e., a first look-up table 830 and a second look-up table 840) established through the method described above. In the present embodiment, the electronic device slides an N-bit search window 800 on the binary sequence of the input data 810 to search for the first bit having the value 1 on the binary sequence. If the electronic device finds the first bit having the value 1, it inputs the value of this first bit and the next N−1 bits into a multiplexer 820. The multiplexer 820 then acquires the N-bit logarithmic value obtained by the search window 800 by using the first look-up table 830. Besides, when the electronic device finds a bit having the value 1, it further outputs the bit number M that the search window 800 is slid on the binary sequence of the input data 810 to a multiplier 850. The multiplier 850 multiplies the bit number M by 3.01171875 (i.e., the quantized approximation of 10 log₁₀2) and outputs the result to an adder 860. The adder 860 adds the output data acquired by the multiplexer 820 from the first look-up table 830 to the output of the multiplier 850 to output the logarithmic value 870 of the input data 810.

On the other hand, if the electronic device does not find any bit having the value 1, it does not input any value (or input the first bit having the value 0) to the multiplexer 820. In this case, the multiplexer 820 acquires the N-bit logarithmic value obtained by the search window 800 by using the second look-up table 840. Additionally, when the electronic device does not find any bit having the value 1, it does not output the bit number M that the search window 800 is slid (or outputs 0). Thus, the adder 860 only obtains the output data acquired by the multiplexer 820 from the second look-up table 840 to output the logarithmic value 870 of the input data 810.

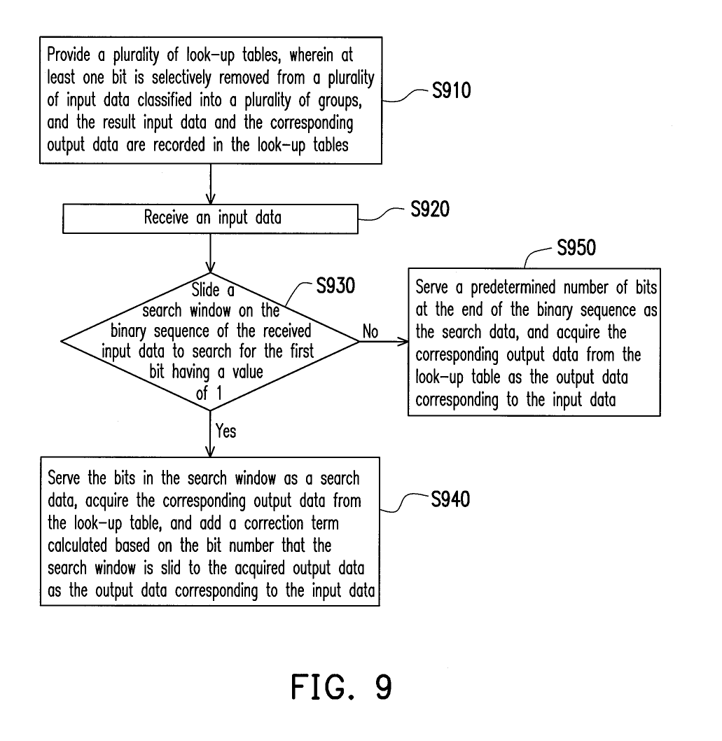

In the present exemplary embodiment, a data acquisition method corresponding to the linear-to-logarithmic conversion table lookup technique described above is also provided. FIG. 9 is a flowchart of a data acquisition method using multiple look-up tables according to an embodiment. Referring to FIG. 9, in the present embodiment, look-up tables are established such that an electronic device can search for an output data corresponding to an input data. Below, the method will be described in detail.

First, a plurality of look-up tables is provided by the electronic device, wherein at least one bit is removed from a plurality of input data that have been classified into one of a plurality of groups, and the result input data and a plurality of output data corresponding to the input data are recorded in the corresponding look-up table (step S910). In foregoing step, the number of bits to be removed from the input data may be determined according to the size of a search window, and the result input data and the corresponding output data are recorded in a corresponding look-up table. Besides, in this step, regarding the input data in which the search window cannot find a corresponding bit, another look-up table is further established for storing the input data and the corresponding output data.

And, an input data is received by the electronic device (step S920) to acquire the output data corresponding to the input data from the look-up table. To be specific, the electronic device slides a search window on the binary sequence of the received input data to search for the first bit having the value 1 (step S930), wherein the search window has a predetermined number of bits.

If the first bit having the value 1 is found, the electronic device uses the bits within the search window as a search data to acquire the corresponding output data from the look-up table, and the electronic devices adds a correction term calculated based on the bit number that the search window is slid to the output data and uses the result as the output data corresponding to the input data (step S940), wherein the correction term may be obtained by multiplying the bit number that the search window is slid by 3.01171875 (i.e., the quantized approximation of 10 log₁₀2).

Contrarily, if the first bit having the value 1 is not found, the electronic device uses a predetermined number of bits at the back end of the binary sequence as the search data to acquire the corresponding output data from the look-up table and uses the acquired output data as the output data corresponding to the input data (step S950).

It should be noted that when the electronic device slides the search window on the binary sequence to search for the first bit having the value 1, it may slide the search window from the MSB to the LSB of the binary sequence. However, how the electronic device slides the search window is not limited in the present embodiment.

In summary, a method for establishing multiple look-up tables and a data acquisition method using multiple look-up tables are provided in exemplary embodiments of the present disclosure, wherein data is classified into a plurality of groups according to the numerical distributions and attributes of input/output data or the system environment so as to establish a plurality of corresponding look-up tables, and some bits are selectively removed from the input data in each look-up table to reduce the size of the look-up table. Thereby, in the present disclosure, the memory space required for recording the look-up tables is reduced, and the speed for the processor to acquire data from the look-up tables is increased.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method for establishing multiple look-up tables, comprising:
classifying a plurality of input data into a plurality of groups;
respectively providing a plurality of input data and a plurality of output data corresponding to the input data to the groups to establish a plurality of corresponding look-up tables;
selectively removing at least one bit from the input data in each of the look-up tables corresponding to at least one of the groups, and recording the result input data and the corresponding output data into the look-up table corresponding to the group.

2. The method according to claim 1, wherein the step of classifying the input data into the groups comprises:
classifying the input data into the groups according to a numerical distribution of the input data.

3. The method according to claim 1, wherein the step of selectively removing at least one bit from the input data in each of the look-up tables corresponding to at least one of the groups and recording the result input data and the corresponding output data into the look-up table corresponding to the group comprises:
performing a plurality of bit removal simulations on the input data in the group, wherein the bit removal simulations are to remove different numbers of front-end bits, back-end bits, or combinations of front-end bits and back-end bits from the input data;
calculating an error between the result input data and the original input data in each of the bit removal simulations;
determining a number of bits to be removed from the input data according to the errors; and
recording the result input data and the corresponding output data into the look-up table corresponding to the group.

4. The method according to claim 3, wherein the step of determining the number of bits to be removed from the input data according to the errors comprises:
calculating a total error of all the look-up tables corresponding to each of a plurality of combinations of the bit removal simulations performed on the look-up tables; and
comparing the individual error or the total error corresponding to each of the combinations with an original error of the input data, and determining the number of bits to be removed from the input data according to the combination having the individual error or the total error closest to the original error.

5. The method according to claim 1, wherein after the step of removing different numbers of front-end bits, back-end bits, or combinations of front-end bits and back-end bits from the input data in the bit removal simulations, the method further comprises:
calculating a table size required for recording the result input data and the corresponding output data after different numbers of bits are removed in the bit removal simulations, recording

6. The method according to claim 5, wherein the step of determining the number of bits to be removed from the input data according to the errors comprises:
comparing the error corresponding to each of the bit removal simulations with a threshold, and selecting at least one of the bit removal simulations having the error smaller than the threshold; and
comparing the table size corresponding to the selected bit removal simulation to determine the number of bits to be removed from the input data.

7. The method according to claim 1, wherein after the step of selectively removing at least one bit from the input data in each of the look-up tables corresponding to at least one of the groups, the method further comprises:
calculating a table size of each of the look-up tables for recording the result input data and the corresponding output data; and
calculating a plurality of addresses corresponding to the input data in the look-up tables according to the table sizes of the look-up tables.

8. The method according to claim 7, wherein the addresses corresponding to the input data in the look-up tables are continuously or individually assigned.

9. The method according to claim 1, wherein after the step of selectively removing at least one bit from the input data in each of the look-up tables corresponding to at least one of the groups and recording the result input data and the corresponding output data into the look-up table corresponding to the group, the method further comprises:
calculating a correction term of each of the output data, and recording the correction term in the corresponding look-up table.

10. A data acquisition method using multiple look-up tables, comprising:
providing a plurality of look-up tables, wherein at least one bit is selectively removed from a plurality of input data classified into a plurality of groups, and the result input data and a plurality of corresponding output data are recorded in each of the look-up tables;
receiving the input data; and
acquiring the output data corresponding to the input data from the look-up tables.

11. The data acquisition method according to claim 10, wherein the step of providing a plurality of look-up tables further comprises:
providing a correction term of each of the output data.

12. The data acquisition method according to claim 11, wherein the step of acquiring the output data corresponding to the input data in the look-up tables further comprises:
acquiring the correction term corresponding to the output data, and correcting the output data acquired from the look-up tables according to the correction term.
